(19) United States
(12) Patent Application Publication
(10) Pub. No.: US 2026/0010924 A1
(43) Pub. Date: Jan. 8, 2026

(54) METHOD AND PROCESSING UNIT FOR RECOMMENDING PRICING VALUE FOR PRODUCTS OF AN ENTERPRISE TO CUSTOMERS

(71) Applicant: Sameer Garg, Chicago, IL (US)

(72) Inventor: Sameer Garg, Chicago, IL (US)

(21) Appl. No.: 18/764,221

(22) Filed: Jul. 4, 2024

(51) Int. Cl. G06Q 30/0201

(52) U.S. Cl. CPC G06Q 30/0206

(57) ABSTRACT

A method and processing unit for recommending pricing value for products to customers is disclosed. Values of customer factors, and product factors are retrieved. Customer factors include current end market positions, current customer revenue, desired growth value, product purchase volume, and gross margin of customer. Product factors comprise product revenue, purchase frequency, and competitiveness values of product. Further, each customer is classified to be associated with customer tier based on customer factors. Each product is classified to be associated with a product tier, based on product factors. Grid is generated for each competitiveness value. The grid represents the relation between product revenue and purchase frequency, and customer tiers. Grid is analyzed to finalize pricing value of products. In response to a request for pricing value of desired product to desired customer, pricing value of desired product is determined based on the analysis, to provide to desired customer.

### FIELD OF THE PRESENT INVENTION

Embodiments of the present invention generally relate to managing pricing of products for customers within an enterprise. In particular, embodiments of the present invention relate to a method and a processing unit for recommending a pricing value for products of an enterprise to one or more customers, based on customer factors and product factors.

### BACKGROUND OF THE DISCLOSURE

Pricing plays a critical role in the revenue and sales performance of a product. Many businesses update their product pricing annually, particularly in industries where companies sell spare parts and consumables alongside off-the-shelf products. For instance, imagine a company selling vacuum cleaners. Such a company not only adjusts the pricing of the vacuum cleaner itself but also of its components and spare parts, like the blower motor, filter, brushes, and rollers.

Traditional methods of updating product pricing typically rely on factors such as revenue, sales volume, and gross margin. However, depending solely on revenue or sales data may not yield optimal pricing, especially when actual demand differs from predictions. Moreover, gross margin, or material margin, is heavily influenced by the efficiency of procurement and manufacturing processes, making it an insufficient indicator for pricing decisions. Additionally, margins are affected by fluctuating costs tied to material volume and supplier choices, which may not accurately reflect customer willingness to pay or the value created for end-customers.

Conventional pricing methodologies often lack advanced analytics and data-backed insights. They overlook crucial product attributes like competitiveness and customization, as well as customer-related factors such as end markets, applications, size, growth potential, and preferences. For example, a semiconductor company may choose not to sell its products to automotive companies, leading to adjusted pricing strategies based on customer industry affiliations.

Recognizing the need for optimal pricing strategies, there's a demand for methodologies and processing units tailored to recommend pricing based on real-time customer and product factors, in addition to revenue, sales, and gross margin considerations.

The information disclosed in this background of the disclosure section is only for enhancement of understanding of the general background of the disclosure and should not be taken as an acknowledgment or any form of suggestion that this information forms existing information already known to a person skilled in the art.

### BRIEF SUMMARY OF THE DISCLOSURE

Pricing stands as one of the paramount aspects of a product to be sold. Setting it too high may hinder profitable sales, while pricing it too low could lead to high unit sales but insufficient profit to sustain the business. The current approach advocates recommending product pricing based on real-time customer and product factors, alongside traditional considerations like revenue, sales, and gross margin. This ensures that pricing is tailored to individual customers while still meeting the company's revenue goals.

The present invention discloses a method, a processing unit, and a non-transitory computer-readable medium for recommending a pricing value for products of an enterprise to one or more customers. For recommending the pricing, initially, values of one or more customer factors associated with one or more customers of an enterprise, and values of one or more product factors associated with one or more products of the enterprise are retrieved. The one or more customer factors, associated with a customer amongst the one or more customers, comprise at least one of current end market positions, current customer revenue, desired growth value, product purchase volume, and gross margin of the customer. The one or more product factors, associated with a product amongst the one or more products, comprise at least one of product revenue, purchase frequency, and one or more competitiveness values of the product. Further, each of the one or more customers are classified to be associated with a customer tier amongst plurality of customer tiers, based on the one or more customer factors. Each of one or more products of the enterprise are classified to be associated with a product tier amongst plurality of product tiers, based on the one or more product factors. A multi-dimensional grid is generated for each of the one or more competitiveness values. The multi-dimensional grid represents relation between the product revenue and the purchase frequency of corresponding product, and the plurality of customer tiers. The multi-dimensional grid is analyzed to finalize the pricing value of the corresponding product to provide to the one or more customers. In response to a request for the pricing value of a desired product amongst the one or more products to a desired customer amongst the one or more customers, the pricing value of the desired product is determined based on the analysis, to provide to the desired customer.

In a non-limiting embodiment, the plurality of product tiers and the plurality of the customer tiers are analyzed to initiate the request for the pricing value.

In a non-limiting embodiment, each of the one or more customers are classified by assigning factor scores to the one or more customer factors for each of the one or more customers, determining a customer score for each of the one or more customers based on the factor scores and classifying each of the one or more customers to be associated with a corresponding customer tier amongst the plurality of customer tiers, based on the customer score.

In a non-limiting embodiment, the plurality of customer tiers comprise N number of customer tiers. A customer with highest value of the customer score is classified to be associated with first customer tier and a customer with lowest value of the customer score is classified to be associated with Nth customer tier.

In a non-limiting embodiment, each of the one or more products is classified by labeling the one or more product factors for each of the one or more products to be one of high, medium, and low and classifying each of the one or more products to be associated with a corresponding product amongst the plurality of product tiers, based on the labeling.

In a non-limiting embodiment, analyzing the multi-dimensional grid related to a selected product tier includes segmenting the multi-dimensional grid to form a plurality of segments for each of the plurality of customer tiers, wherein each segment of the plurality of segments associated with a customer tier indicates historic pricing values under every label of the product revenue and the product purchase frequency of the corresponding product tier, inputting a target pricing value for the corresponding product tier in a segment associated with first customer tier with the product revenue and the product purchase frequency labeled as high and finalizing the pricing values of the one or more products for the one or more customers by computing the pricing values relative to said target pricing value.

In a non-limiting embodiment, identifying the pricing value of the desired product comprises selecting a segment from the plurality of segments, associated with the desired product and the desired customer and analyzing the segment to identify the pricing value of the desired product.

In a non-limiting embodiment, the products purchase volume represents at least one of historic volume of purchase, desired volume of purchase, and deviation volume of purchase of the product by the customer, wherein the deviation volume is difference between committed purchase and actual purchase of the product by the customer.

In a non-limiting embodiment, the request is associated with one of a new pricing or revised pricing of the product.

In a non-limiting embodiment, the pricing value recommended to the user is one of a fixed price of the desired product and a discount value offered on the fixed price of the desired product.

The features and advantages of the subject matter hereof will become more apparent in light of the following detailed description of selected embodiments, as illustrated in the accompanying FIGUREs. As one of ordinary skill in the art will realize, the subject matter disclosed herein is capable of modifications in various respects, all without departing from the scope of the subject matter. Accordingly, the drawings and the description are to be regarded as illustrative.

### BRIEF DESCRIPTION OF THE DRAWINGS

The present subject matter will now be described in detail with reference to the drawings, which are provided as illustrative examples of the subject matter to enable those skilled in the art to practice the subject matter. It will be noted that throughout the appended drawings, features are identified by reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 illustrates an exemplary environment with a processing unit for recommending a pricing value for products of an enterprise to one or more customers, in accordance with an embodiment of the present invention;

FIGS. 2A, 2B, and 2C illustrate detailed block diagrams showing functional modules of a processing unit for recommending a pricing value for products of an enterprise to one or more customers, in accordance with an embodiment of the present invention;

FIGS. 3A-3G show exemplary embodiments for recommending a pricing value for products of an enterprise to one or more customers, in accordance with an embodiment of the present invention;

FIGS. 4A-4D is an exemplary process of processing unit for recommending a pricing value for products of an enterprise to one or more customers, in accordance with an embodiment of the present invention; and

FIG. 5 illustrates an exemplary computer unit in which or with which embodiments of the present invention may be utilized.

### DETAILED DESCRIPTION OF THE EMBODIMENTS

The detailed description set forth below in connection with the appended drawings is intended as a description of exemplary embodiments in which the presently disclosed invention can be practiced. The term “exemplary” used throughout this description means “serving as an example, instance, or illustration,” and should not necessarily be construed as preferred or advantageous over other embodiments. The detailed description includes specific details to provide a thorough understanding of the presently disclosed invention. However, it will be apparent to those skilled in the art that the presently disclosed invention may be practiced without these specific details. In some instances, well-known structures and devices are shown in block diagram form in order to avoid obscuring the concepts of the presently disclosed invention.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and/or firmware.

Embodiments of the present invention may be provided as a computer program product, which may include a non-transitory, machine-readable storage medium tangibly embodying thereon instructions, which may be used to program the computer (or other electronic devices) to perform a process. The machine-readable medium may include but is not limited to, fixed (hard) drives, semiconductor memories, such as Read Only Memories (ROMs), Programmable Read-Only Memories (PROMs), Random Access Memories (RAMs), Erasable PROMs (EPROMs), Electrically Erasable PROMs (EEPROMs), flash memory or other types of media/machine-readable medium suitable for storing electronic instructions (e.g., computer programming code, such as software or firmware).

Various methods described herein may be practiced by combining one or more non-transitory, machine-readable storage media containing the code according to the present invention with appropriate standard computer hardware to execute the code contained therein. An apparatus for practicing various embodiments of the present invention may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Embodiments of the present invention relate to a method, a processing unit, and a non-transitory computer-readable medium for recommending a pricing value for products of an enterprise to one or more customers. In the proposed system and method, the pricing of the product is based on real-time customer and product factors, alongside traditional considerations like revenue, sales, and gross margin. The present approach includes classifying the customers and the products associated with the enterprise to multiple tiers and further generating a grid based on the tiers. Further, the grid is segmented to determine and recommend the pricing values for desired products and desired customers. By this, the recommended pricing value is optimal and specific to the customers and ensures that pricing is tailored to meet the company's revenue goals.

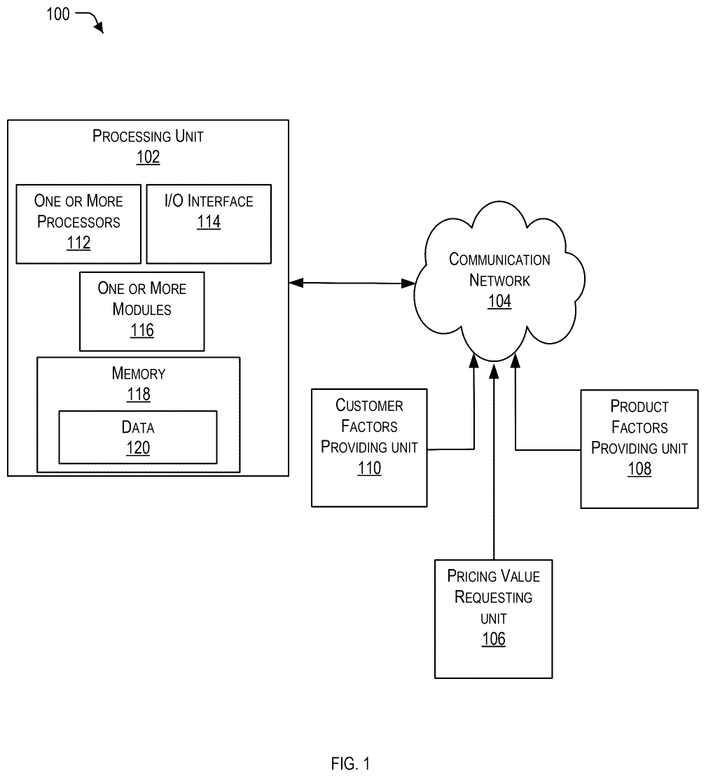

FIG. 1 illustrates an exemplary environment 100 with processing unit 102 for recommending a pricing value for products of an enterprise to one or more customers, in accordance with an embodiment of the present invention. As shown in FIG. 1, the exemplary environment 100 comprises the processing unit 102, a communication network 104, a pricing value requesting unit 106, a product factors providing unit 108, and a customer factors providing unit 110. In an embodiment, the exemplary environment 100 may be integral part of computing systems or servers associated with the enterprise. In an embodiment, the enterprise may be an industry which sells off-the shelf products and its components. In an embodiment, the enterprise may also be the manufacturer of the off-the shelf products and its components and has a requirement to determine Maximum Retail Price (MRP) of the products. In an embodiment, the enterprise may be a seller of the off-the shelf product and its components. The off-the shelf product may be an end-product which constitutes one or more components. For example, the off-the shelf product may be a vacuum cleaner and its components may be a fan blade, electric motor, exhaust port, vacuum filters, vacuum fan, and so on. Consider the enterprise is related to a semi-conductor industry. In such a case, the off-the shelf product may be a system-on-chip and its one or more components may include graphics processor, memory, USB controller, power management circuits, wireless radios and so on.

The proposed processing unit 102 in the exemplary environment 100 is configured to determine and recommend pricing value of the products to the one or more customers. The processing unit 102 may communicate with the pricing value requesting unit 106, the product factors providing unit 108, and the customer factors providing unit 110, associated with the enterprise, to determine and recommend the pricing value to the one or more customers. In an embodiment, the processing unit 102 may be connected with the pricing value requesting unit 106, the product factors providing unit 108, and the customer factors providing unit 110, via the communication network 104. The pricing value requesting unit 106 may be configured to initiate a request for determining the pricing value of the desired product and recommend the pricing value to the desired customer. The product factors providing unit 108 may be configured to provide values of the one or more product factors to the processing unit 102. The customer factors providing unit 110 may be configured to provide values of the one or more customer factors to the processing unit. The communication network 104 may include, without limitation, a direct interconnection, a Local Area Network (LAN), a Wide Area Network (WAN), a wireless network (e.g., using Wireless Application Protocol), the Internet, and the like. In an alternate embodiment, the processing unit 102 may be connected with each of the pricing value requesting unit 106, the product factors providing unit 108, and the customer factors providing unit 110 via a corresponding dedicated communication network (not shown in Figures).

The processing unit 102, in communication with the pricing value requesting unit 106, the product factors providing unit 108, and the customer factors providing unit 110, may be configured to recommend the pricing value of a desired product to a desired customer. The pricing value requesting unit 106 may be configured to initiate a request for determining the pricing value of the desired product and recommend the pricing value to the desired customer. In an embodiment, the request may be automatically triggered and initiated by the pricing value requesting unit 106. In such an embodiment, for automatically triggering the request, the pricing value requesting unit 106 may be configured to analyze the plurality of product tiers and the plurality of the customer tiers to initiate the request for the pricing value.

Further, in an embodiment, the pricing value requesting unit 106 may be integral part of the processing unit 102. In an embodiment, the pricing value requesting unit 106 may be scheduled to analyze the plurality of product tiers and the plurality of customer tiers. For example, the pricing value requesting unit 106 may be configured to request for the pricing value yearly, half yearly, or quarterly. In an embodiment, the pricing value requesting unit 106 may be a user device associated with a user related to the enterprise. In such an embodiment, the user, using the pricing value requesting unit 106, may manually trigger the request for the pricing value. In another embodiment, the pricing value requesting unit 106 may be a user device associated with a customer. In such an embodiment, the customer may manually trigger the request for a pricing value of a desired product. In such a case, the pricing value requesting unit 106 may provide an option to the user or the customer to select the desired products amongst the one or more products associated with the enterprise. In an embodiment, the request may be related to determining a new pricing value of the desired product. In another embodiment, the request may be related to determining revised pricing value of the desired product. Once the request is generated by the pricing value requesting unit 106, said request is provided to the processing unit 102 for determining and recommending the pricing value. In an embodiment, the pricing value requesting unit 106 may be but is not limited to, at least one of a smartphone, a head-mounted device, smart glasses, a television, a PC, a tablet, a laptop, and so on, associated with the user or the customer.

In an embodiment, the processing unit 102 may be configured to function upon receiving a request to recommend the pricing values. In an embodiment, the request may be manually provided by the user via the pricing value requesting unit 106. When providing the request, the user may be prompted to select the desired product and the desired customer. In an embodiment, the request may be to recommend the pricing value for all of the one or more products and all of the one or more customers. In an embodiment, the request may be auto-generated by the pricing value requesting unit 106. The auto-generation of the request may be scheduled. For example, the request to recommend the pricing value may be generated yearly, half yearly, or quarterly for the enterprise. In an embodiment, the pricing value requesting unit 106 may be integral part of the processing unit 102. In such an embodiment, for the auto-generation of the request, the processing unit 102 may be configured to analyze one of the plurality of product tiers and the plurality of the customer tiers to initiate the request for recommending the pricing value. In an embodiment, the request may be associated with one of a new pricing or revised pricing of the product. For example, if a customer associated with first customer tier and pricing values of a product related to the customer is not optimal, i.e., highly price or lowly discounted, a request to revise the pricing value may be generated. In an embodiment, the analyzing of the plurality of product tiers and the plurality of the customer tiers may be scheduled at a predefined time. In an embodiment, the request may be generated when a new customer requests for a pricing value of a product to the enterprise. In an embodiment, the request may be generated when existing customer requests for a revised pricing value of a product to the enterprise. In an embodiment, the request may be generated when the enterprise initiates to sell a new product to the one or more customers. In an embodiment, the request may be generated when there is need for the enterprise to increase revenue and sales of the enterprise or the one or more products of the enterprise.

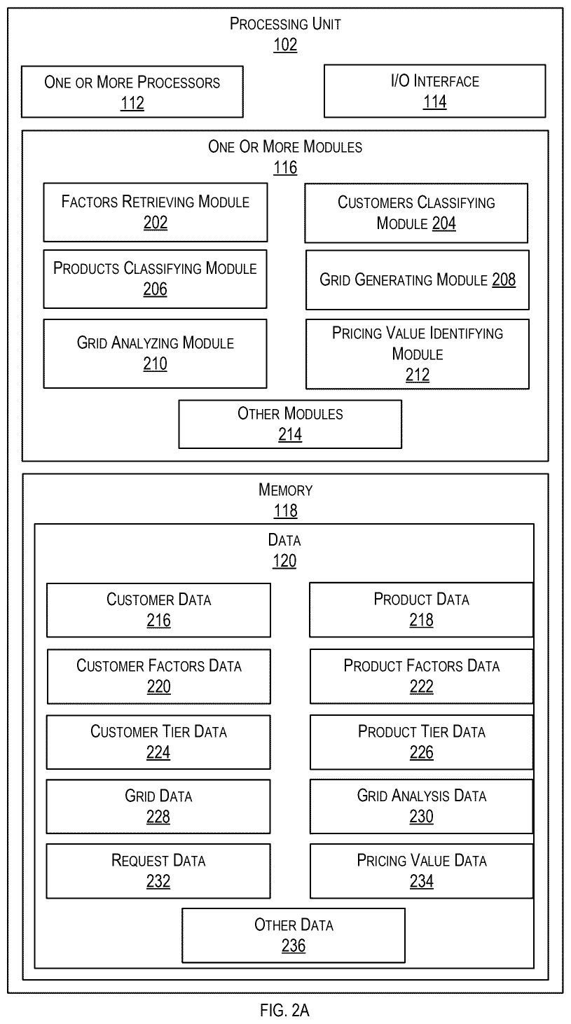

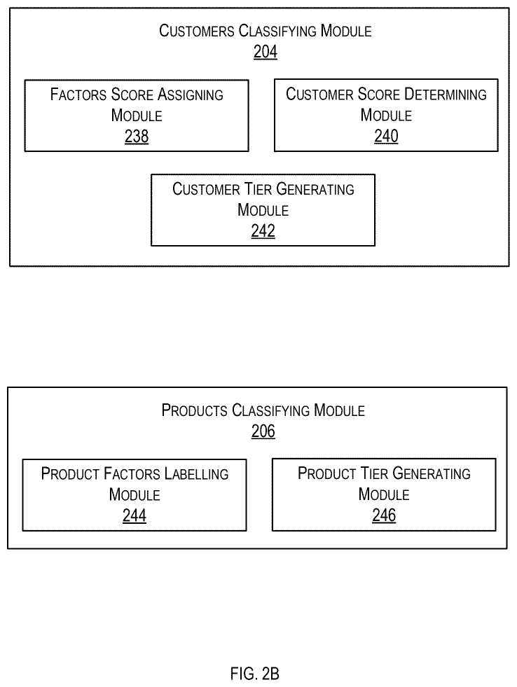

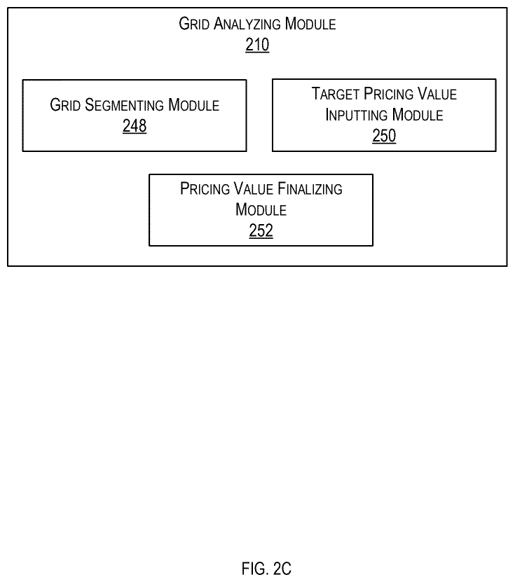

FIG. 2A shows a detailed block diagram of the processing unit 102 for recommending the pricing value for products of the enterprise to the one or more customers, in accordance with some non-limiting embodiments or aspects of the present disclosure. The processing unit 102 may include one or more processors 112, an Input/Output (I/O) interface 114, one or more modules 116, and a memory 118. In some non-limiting embodiments or aspects, the memory 118 may be communicatively coupled to the one or more processors 112. The memory 118 stores instructions, executable by the one or more processors 112, which on execution, may cause the processing unit 102 to recommend the pricing value. In some non-limiting embodiments or aspects, the memory 118 may include data 120. The one or more modules 116 may be configured to perform the steps of the present disclosure using the data 120 to recommend the pricing value. In some non-limiting embodiments or aspects, each of the one or more modules 116 may be a hardware unit, which may be outside the memory 118 and coupled with the processing unit 102. In some non-limiting embodiments or aspects, the processing unit 102 may be implemented in a variety of computing systems, such as a laptop computer, a desktop computer, a Personal Computer (PC), a notebook, a smartphone, a tablet, e-book readers, a server, a network server, a cloud server, and the like. In a non-limiting embodiment, each of the one or more modules 116 may be implemented with a cloud-based server, communicatively coupled with the processing unit 102.

The data 120 in the memory 118 and the one or more modules 116 of the processing unit 102 are described herein in detail. In one implementation, the one or more modules 116 may include but is not limited to, a factors retrieving module 202, a customers classifying module 204, a products classifying module 206, a grid generating module 208, a grid analyzing module 210, a pricing value identifying module 212 and one or more other modules 214 associated with the processing unit 102. In some non-limiting embodiments or aspects, the data 120 in the memory 118 may include customer data 216, product data 218, customer factors data 220 (herewith also referred to as one or more customer factors 220), product factors data 222 (herewith also referred to as one or more product factors 222), customer tier data 224 (herewith also referred to as plurality of customer tiers 224), product tier data 226 (herewith also referred to as plurality of product tiers 226), grid data 228, grid analysis data 230, request data 232 (herewith also referred to as request 232), pricing value data 234 (herewith also referred to as pricing value 234) and other data 236 associated with the processing unit 102.

In some non-limiting embodiments or aspects, the data 120 in the memory 118 may be processed by the one or more modules 118 of the processing unit 102. In some non-limiting embodiments or aspects, the one or more modules 118 may be implemented as dedicated units and when implemented in such a manner, the modules may be configured with the functionality defined in the present disclosure to result in novel hardware. As used herein, the term module may refer to an Application Specific Integrated Circuit (ASIC), an electronic circuit, Field-Programmable Gate Arrays (FPGA), a Programmable System-on-Chip (PSoC), a combinational logic circuit, and/or other suitable components that provide the described functionality. The one or more modules 118 of the present disclosure recommend the pricing value 234 of the desired product to the desired customer. The one or more modules 118 along with the data 120, may be implemented in any system within any enterprise for recommending the pricing value 234 of the one or more products to the one or more customers of the enterprise.

In an embodiment, the processing unit 102 may be configured to function for a dedicated enterprise and recommend pricing value of the products of the enterprise to the customers of the enterprise. In an embodiment, the processing unit 102 may be associated with multiple enterprises. In such an embodiment, the processing unit 102 may be configured to receive data related to products and customers of an enterprise amongst the multiple enterprises and recommend the pricing values for the products of that enterprise. In an embodiment, each of the multiple enterprises may be associated with corresponding pricing value requesting unit, corresponding product factors providing unit, and corresponding customer factors providing unit. In an alternate embodiment, the pricing value requesting unit 106, the product factors providing unit 108, and the customer factors providing unit 110 may be configured to retrieve request, one or more product factors 222 and one or more customer factors 220, respectively from each of the multiple enterprises, to provide to the processing unit 102 (not shown in the figures).

For recommending the pricing value 234, the factors retrieving module 202 may be configured to retrieve values of the one or more customer factors 220, and values of the one or more product factors 222. The one or more product factors 222 may be retrieved from the product factors providing unit 108. The one or more customer factors 220 may be retrieved from the customer factors providing unit 110.

The customer factors providing unit 110 may be configured to provide values of the one or more customer factors 220 to the processing unit 102, for recommending the pricing value 234 to the one or more customers of the enterprise. The one or more customer factors 220 relates to each of the one or more customers associated with the enterprise. In an embodiment, the one or more customer factors may be determined based on information associated with the one or more customers. The information associated with the one or more customers may include list of customers of the enterprise, revenue generated from the one or more customers, sales of the one or more customers, preferences related to the one or more customers, industry information of the one or more customers, products related to the one or more customers and so on. Such information may be stored as the customer data 216 in the memory 118. The one or more customer factors 220 may include, but is not limited to, at least one of current end market position, current customer revenue, desired growth value, products purchase volume, and gross margin of the customer. The current end market position of a customer may indicate position of the customer amongst the one or more customers of the enterprise. In an embodiment, value of the current end market position may be determined based on preference of the enterprise, relation of the enterprise with each of the one or more customers, current sales, and so on. For example, consider the enterprise is a pump manufacturer and prefers to sell pumps to appliances industry over a food chain industry and automotive industry. Thus, customer associated with the appliances industry may be provided with higher value of the current end market position over that of the food chain industry and the automotive industry. The current customer revenue of a customer may indicate the revenue generated by the customer. In an embodiment, at least one of overall revenue and product specific revenue may be considered to provide a value for the current customer revenue. In an embodiment, the current customer revenue may be provided with a value based on the revenue generated for a predefined period of time. The desired growth value of the customer indicates on how much the customer needs to grow in relation with the enterprise. The products purchase volume of a customer is a futuristic data of how much volume of a product the customer is going to purchase from the enterprise. The products purchase volume may be a predicted data or a data committed by the customer. The gross margin of the customer indicates overall profit that the enterprise has benefitted due to the purchases of the customer. In an embodiment, the gross margin of the customer may be a percentage of total gross margin. The total gross margin may be computed using data associated with all of the one or more customers of the enterprise. For example, the gross margin of the customer may be 40% of the total gross margin of the enterprise. In an embodiment, value of the gross margin may indicate the gross margin of the customer to be one of accretion and dilution from the total gross margin. In an embodiment, the customer factors providing unit 110 may be configured to automatically compute and determine the values of the one or more customer factors 220. In an embodiment, the customer factors providing unit 110 may be configured to compute the one or more customer factors 220 using data extracted from enterprise database. One or more techniques, known to a person skilled in the art, may be implemented to compute the one or more customer factors. In an embodiment, the values of the one or more customer factors 220 may range from 0 to 10. In an embodiment, the values of the one or more customer factors 220 may be a percentage value. In another embodiment, the values of the one or more customer factors 220 may be manually fed by the user to the processing unit 102 via the customer factors providing unit 110. In such a case, the customer factors providing unit 110 may be a user device associated with the user. In an embodiment, the customer factors providing unit 110 as the user device may prompt the user with an option to choose a value of the one or more customer factors 220. The values of the one or more customer factors 220 and any other information related to the one or more customer factors 220 may be stored as the customer factors data 220 in the memory 118.

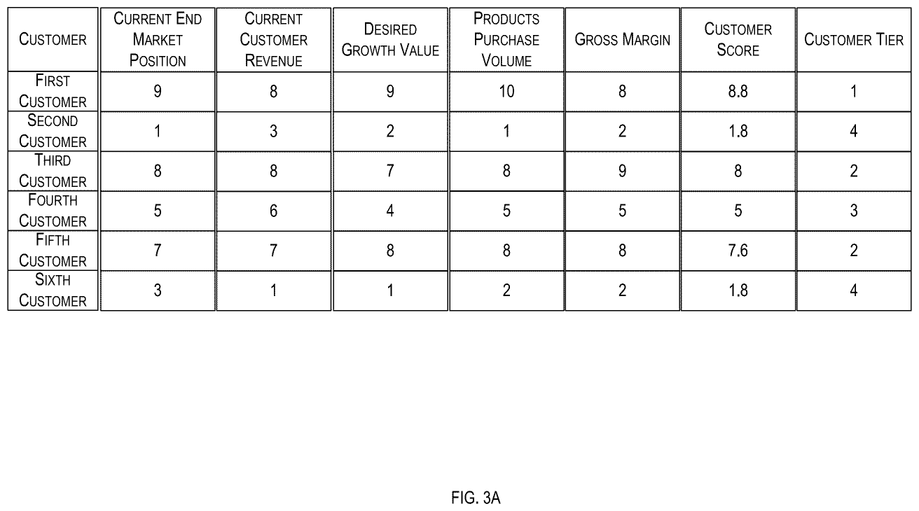

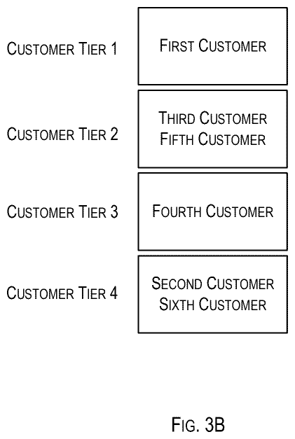

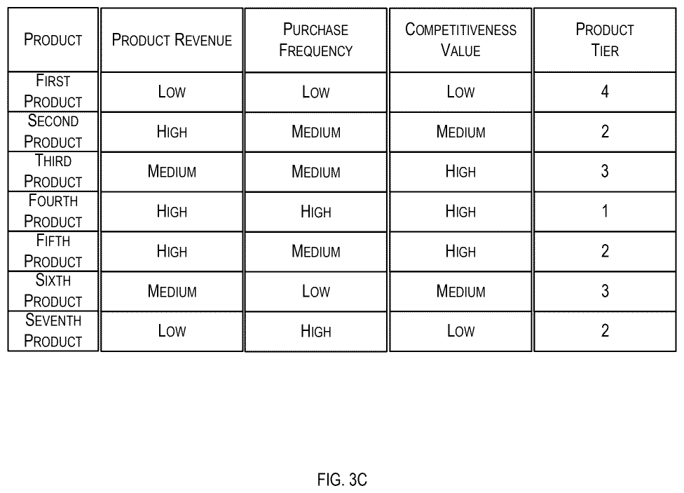

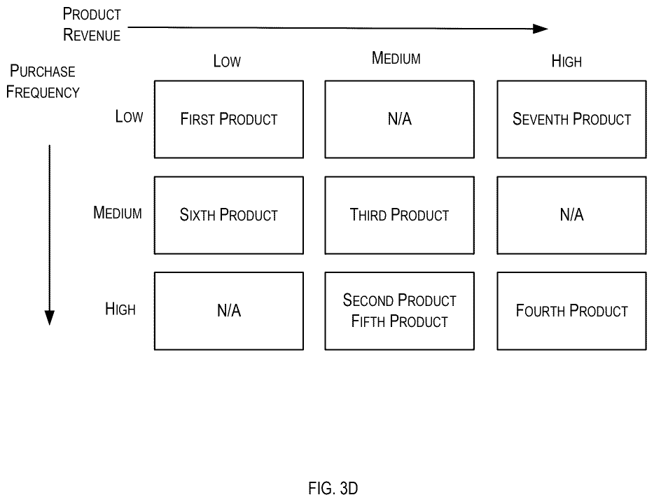

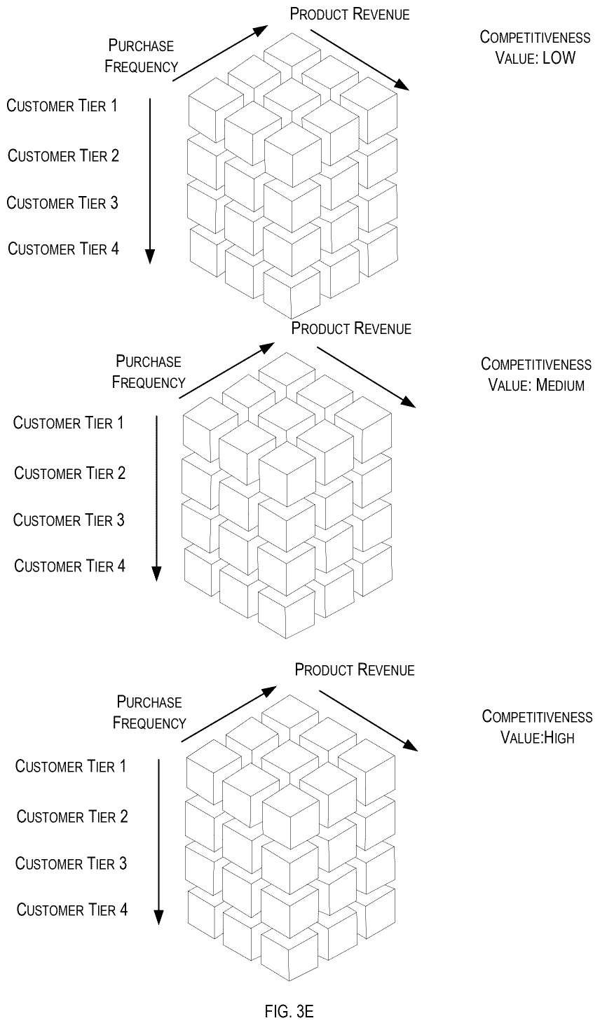

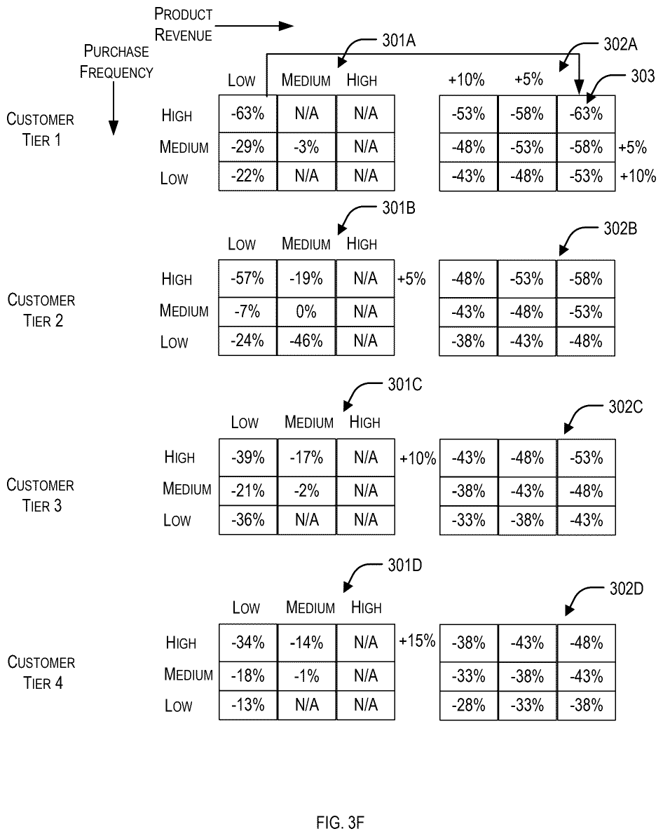

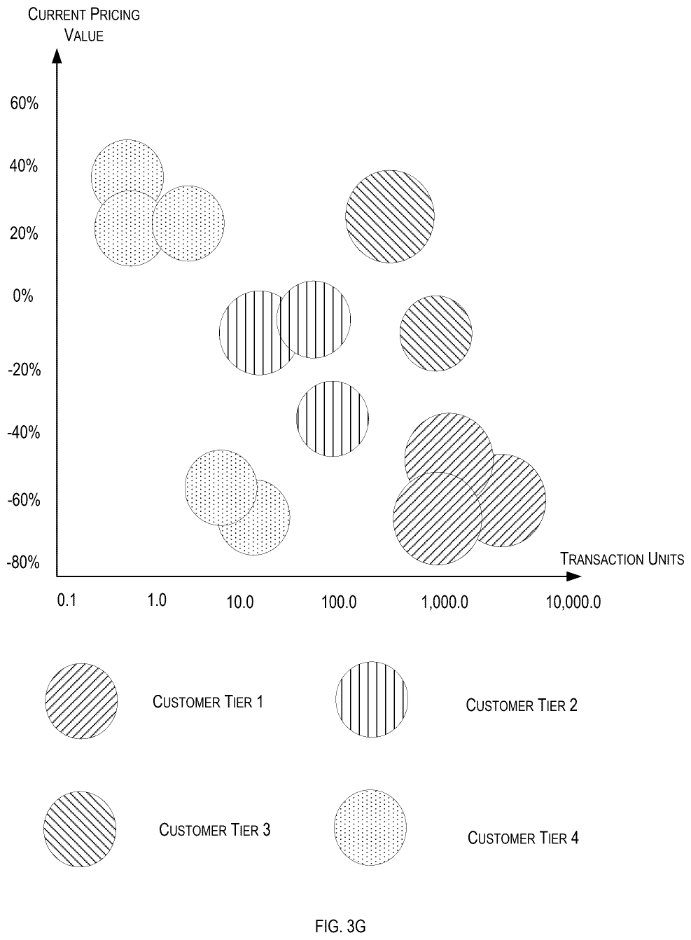

The product factors providing unit 108 may be configured to provide values of the one or more product factors to the processing unit 102. In an embodiment, the one or more product factors may be determined based on information associated with the one or more products of the enterprise. The information associated with the one or more products may include list of products of the enterprise, revenue generated from each of the one or more products, sales associated with the one or more products, preferences related to the one or more products, demand parameters of the one or more products and so on. Such information may be stored as the product data 218 in the memory 118. In a non-limiting embodiment, the one or more product factors 222, associated with a product amongst the one or more products, may include at least one of product revenue, purchase frequency, and one or more competitiveness values of the product. In an embodiment, the product revenue indicates monetary revenue generated by the product for the enterprise. In such an embodiment, the value of the product revenue may be obtained for a predefined period of time. In an embodiment, the product factors providing unit 108 may be a computing unit which is configured to compute the product revenue. The product revenue of a product may be computed based on details related to the product. Said details may include but is not limited to, sales of the product and current pricing value of the product. In an embodiment, the product factors providing unit 108 may be configured to automatically extract the details required for computing the product revenue from resources associated with the enterprise. The purchase frequency of a product may indicate frequency of past purchases of the product. The purchase frequency of a product for a predefined period may be considered for determining and recommending the pricing value 234. The one or more competitiveness values of the product may indicate the demand for the product amongst the one or more customers. In an embodiment, the one or more competitiveness values may be computed for each of the one or more products of the enterprise. In an embodiment, the one or more competitiveness values may be computed based on at least one of the current pricing values, demanded quantity, sales values, pre-order details and so on, associated with a corresponding product. In an embodiment, the values of the product revenue, the purchase frequency, and the one or more competitiveness values may be one of high, medium and low. In an embodiment, the values of the product revenue, the purchase frequency, and the one or more competitiveness values may be manually fed by the user to the processing unit 102 via the product factors providing unit 108. In such a case, the product factors providing unit 108 may be a user device associated with the user. In an embodiment, the product factors providing unit 108 as the user device may prompt the user with an option to choose a value of the one or more product factors 222 to be one of high, medium, or low. An exemplary representation of values of the one or more product factors 222 is shown in FIG. 3C. In an embodiment, the values of the one or more product factors 222 may be dynamically computed and saved in the database associated with the enterprise and retrieved by the product factors providing unit 108 when recommending the pricing value 234. In an embodiment, said database may be integral part of the product factors providing unit 108. The values of the one or more product factors 222 and any other information related to the one or more product factors 222 may be stored as the product factors data 222 in the memory 118.

Upon retrieving values of the one or more customer factors 220 and one or more product factors 222, the customers classifying module 204 may be configured to classify each of one or more customers of the enterprise to be associated with a customer tier amongst the plurality of customer tiers 224. The classification may be based on one or more customer factors 220. FIG. 2B shows a detailed block diagram of the customers classifying module 204. The customers classifying module 204 may include a factors score assigning module 238, a customer score determining module 240, and a customer tier generating module 242. For classifying the one or more customers, the factors score assigning module 238 may be configured to assign factor scores to the one or more customer factors 220 for each of the one or more customers. In an embodiment, the values of the one or more customer factors 220 may be the factors scores. Such values may be dynamically computed and saved in the database associated with the enterprise and retrieved by the customer factors providing unit 110 when recommending the pricing value 234. In an embodiment, said database may be integral part of the customer factors providing unit 110. As shown in FIG. 3A, the values of the one or more customer factors 220 may be within the range of 1-10. In an embodiment, the factors score assigning module 238 may directly provide the values of the one or more customer factors 220. In an embodiment, the factors score assigning module 238 may be configured to provide information and data that may be required to finalize the value of each of the one or more customer factors 220. Said information and data may relate to one or more customers of the enterprise. Using such information and the data, the customers classifying module 204 may be configured to assign the value to the one or more customer factors 220.

Upon assigning the values to the one or more customer factors 220, the customer score determining module 240 may be configured to determine a customer score for each of the one or more customers of the enterprise. The customer score may be computed to be average of the values of the one or more customer factors 220 as shown in FIG. 3A. In another embodiment, the customer score may be total of values of the one or more customer factors 220. One or more other techniques, known to a person skilled in the art, may be implemented to compute the customer score for each of the one or more customers, using the value of the one or more customer factors 220.

Using the customer score associated with each of the one or more customers, the customer tier generating module 242 may be configured to classify each of the one or more customers to be associated with a customer tier amongst the plurality of customer tiers 224. In an embodiment, the plurality of customer tiers 224 may include N number of customer tiers. The customer with highest value of the customer score may be classified to be associated with first customer tier and a customer with lowest value of the customer score may be classified to be associated with Nth customer tier. From the example illustrated in FIG. 3A, the plurality of customer tiers 224 include four tiers. In an embodiment, the customer with customer score more than 8 may be classified to be associated with first customer tier (i.e., customer tier 1). The customer with customer score between 7 and 8 may be classified to be associated with second customer tier (i.e., customer tier 2). The customer with customer score between 4.5 and below 7 may be classified to be associated with third customer tier (i.e., customer tier 3). The customer with customer score below 4.5 may be classified to be associated with fourth customer tier (i.e., customer tier 4). Thus, the first customer is classified to be associated with first customer tier. The third customer and the firth customer are classified to be associated with second customer tier. The fourth customer is classified to be associated with third customer tier. The second customer and the sixth customer are classified to be associated with fourth customer tier. One or more other criteria may be implemented to classify the one or more customers to be associated with one of the plurality of customer tiers 224. In an embodiment, upon classification, the customer tier generating module 242 may be configured to generate 2D grid to represent the plurality of customer tiers 224. An exemplary representation of the 2D grid formed for the customers and the customer tier illustrated in FIG. 3A, is shown in FIG. 3B. In an embodiment, the 2D grid representing the customer tiers may be 4×1 grid. In another embodiment, the plurality of customer tiers 224 may be represented in form of a pyramid. Any other form of pictorial representation may be used to represent the plurality of customer tiers including the one or more customers.

Further, the products classifying module 206 may be configured to classify each of one or more products of the enterprise to be associated with a product tier amongst plurality of product tiers 226. The products classifying module 206 may perform the classification based on the one or more product factors 222. FIG. 2B shows a detailed block diagram of the products classifying module 206. The products classifying module 206 may include a product factors labelling module 244 and a product tier generating module 246. The product factors labelling module 244 may be configured to label the one or more product factors for each of the one or more products. In an embodiment, each of the one or more product factors 222 may be labelled to be one of high, medium, and low. The values of the one or more product factors 222 may be the labels assigned by the product factors labelling module 244. In an embodiment, the values of the one or more product factors 222 may be dynamically computed and saved in the database associated with the enterprise and retrieved by the products providing unit 108 when recommending the pricing value 234. In an embodiment, said database may be integral part of the products factors providing unit 108. An exemplary representation of the labels provided to products of an enterprise is shown in FIG. 3C. Consider, the products of the enterprise may include first product, second product, third product, fourth product, fifth product, sixth product, and seventh product.

Based on the labeling, the product tier generating module 246 may be configured to classify each of the one or more products to be associated with a corresponding product amongst the plurality of product tiers 226. In an embodiment, the product revenue and the purchase frequency amongst the one or more product factors 222 may be considered to classify the one or more products. In an embodiment, when all the factors are high for a product, the product may be classified to be associated with the product tier 1. When at least of the one or more product factors 222 are high for a product, the product may be classified to be associated with the product tier 2. When none of the one or more product factors 222 are all the factors are high for a product, the product may be classified to be associated with the product tier 1. In an embodiment, 2D grid may be generated to represent the plurality of product tiers 226. In such 2D grid, first dimension may indicate values of the product revenue and the second dimension may indicate the values of the purchase frequency as shown in FIG. 3D. In an embodiment, the 2D grid representing the product tiers may be 3×3 grid. Each of the one or more products may be placed within the 2D grid at corresponding values of the product revenue and the purchase frequency.

Upon classifying the one or more customers and the one or more products, the grid generation module 208 may be configured to generate a multi-dimensional grid for each of the one or more competitiveness values. The multi-dimensional grid represents relation between the product revenue and the purchase frequency of corresponding product, and the plurality of customer tiers 224. In an embodiment, the grid generation module 208 may be configured to combine the customer tier and the product tier to form the multi-dimensional grid. An exemplary representation of the multi-dimensional grids formed for each of the values of the competitiveness values is illustrated in FIG. 3E. In the figure, the multiple dimensional grid is formed for low, medium, and high labels of the competitiveness values. The multi-dimensional grid shown in FIG. 3E is 4×3×3 grid. With the increase in the number of the plurality of customer tiers 224 and the plurality of product tiers 226, the dimension of the grid may increase. The multi-dimensional grids generated by the grid generating module 208 may be stored as the grid data 228 in the memory 118.

FIG. 2C shows a detailed block diagram of the grid analyzing module 210. Using the generated multi-dimensional grids, the grid analyzing module 210 may be configured to analyze the multi-dimensional grid to finalize the pricing value 234 of the corresponding product. The grid analyzing module 210 may include a grid segmenting module 248, a target pricing value inputting module 250, and a pricing value finalizing module 252. For analyzing the multi-dimensional grid, the grid segmenting module 248 may be configured to segment the multi-dimensional grid to form a plurality of segments for each of the plurality of customer tiers 224. Each segment of the plurality of segments associated with a customer tier indicates historic pricing values under every label of the product revenue and the product purchase frequency of the corresponding product tier. Exemplary representation of the plurality of segments associated with each of the plurality of customer tiers 224 is shown in FIG. 3F. Segment 301A is associated with customer tier 1. Segment 301B is associated with customer tier 2. Segment 301C is associated with customer tier 3. Segment 301C is associated with customer tier 4. The plurality of segments 301A, 301B, 301C and 301D includes historic pricing values of the one or more products for each of the plurality of customer tiers 224. In the exemplary example provided in FIG. 3F, the historic values of the pricing values are included in form of discount rate provided on the pricing of each of the one or more products. For example, product with low product revenue and high purchase frequency is provided to customers under customer tier 1 with 63% discount. Similarly, products with medium product revenue and medium purchase for customers under customer tier 2 are provided with 0% discount. If no product exist for certain values of product revenue and purchase frequency for a particular customer tier, such parts of the segments are named as N/A. In another embodiment, the historic values of the pricing values may be in form of a fixed price.

Further, the target pricing value inputting module 250 may be configured to input a target pricing value for the corresponding product tier in a segment associated with first customer tier with the product revenue and the product purchase frequency labeled as high. In an embodiment, the target pricing value may be maximum discount value that the enterprise can offer for the one or more products to the one or more customers. In an embodiment, the target pricing value may be inputted or selected by the user of the enterprise. In another embodiment, the target pricing value inputting module 250 may be configured to compute the target pricing value based in multiple parameters. The multiple parameters may include, revenue parameter, sales parameter, monetary margins, and so on, associated with the enterprise. In such an embodiment, one or more trained models may be implemented in the target pricing value inputting module 250 to determine the target pricing value.

Once the target pricing value is finalized and inputted, the pricing value finalizing module 252 may be configured to finalize the pricing values of the one or more products for the one or more customers by computing the pricing values relative to said target pricing value. The discount value of the products may be reduced for medium values of the product revenue and the purchase frequency, and further reduced to low values of the product revenue and the purchase frequency. In an embodiment, predefined values of reduction of discount values may be set to finalize the pricing values for the plurality of segments of the customer tier 1. As shown in FIG. 3F, the discount value may be reduced by 5% for the products with medium values of the product revenue and the purchase frequency. Further, the discount value may be reduced by 10% for the products with low values of the product revenue and the purchase frequency. For customer tier 2, the pricing value for product with low product revenue and high purchase frequency (i.e., the target pricing value of the customer tier 2) is set to be reduced by predefined percentage over highest discount value of the previous tier. As shown in FIG. 3F, with the predefined percentage to be 5%, the target pricing value of the customer tier 2 is computed to be 5% of the 63% which is 58%. Further, discount values for other products is relatively calculated using the same logic that is used for the customer tier 1. This logic is implemented for rest of the customer tiers to finalize the pricing values of each of the one or more products for each of the one or more customers. In an embodiment, information relating to analyzing the grid, such as grid segmenting information, historic pricing values, target pricing values, predefined values, computed values of the pricing, and so on, may be stored as the gris analysis data 230 in the memory 118.

Upon finalizing the pricing values, the pricing value identifying module 212 is configured to identify the pricing value 234. The pricing value 234 may be identified when a request 232 for the pricing value 234 of a desired product amongst the one or more products is requested for a desired customer amongst the one or more customers. As described previously the pricing value requesting unit 106 may automatically trigger the request for the pricing value. In such an embodiment, for automatically triggering the request, the pricing value requesting unit 106 may be configured to analyze the plurality of product tiers and the plurality of the customer tiers to initiate the request for the pricing value. In an embodiment, analyzing the plurality of customer tiers may include to map the plurality of customer tiers with current pricing value of each of the one or more customers and transactions units associated with the one or more customers. An exemplary representation of the mapping is shown in FIG. 3G. In the exemplary representation, the current pricing value is included in form of discount offered to the one or more customers. It is ideal that a customer from customer tier 1 and with higher value of the transaction units is offered higher value of discount. Similarly, for a customer from customer tier 4 and with lower value of the transaction units, lower value of the discount is to be offered. If a particular customer is positioned in said ideal manner within the mapping, the request for the pricing value may be generated for such a customer. For example, in the mapping, some of the customers, belonging to the customer tier 4 and with lower value of the transactions units are provided with higher value of the discount. A request for the pricing value may be generated for such customers. Similar mapping may be implemented for the plurality of product tiers.

In response to the request 232, the pricing value identifying module 212 may be configured to identify the pricing value 234 of the desired product within the plurality of segments. The pricing value identifying module 212 may initially be configured to select the segments to customer tier of the desired customer. For example, if the desired customer is first customer, the segment related to the customer tier 1 is selected. Similarly, if the desired customer is fourth customer, the segment related to the customer tier 3 is selected. Once the segment is selected, the pricing value 234 which is finalized for values of the product revenue and the purchase frequency corresponding to the desired product is identified as the pricing value 234 of the desired product. The pricing value identifying module 212 recommends the pricing value 234 to the desired customer.

In some non-limiting embodiments or aspects, the processing unit 102 may receive data for recommending the pricing value via the I/O interface 114. The received data may include, but is not limited to, at least one of the customer data 216, the product data 218, the one or more customer factors 220, the one or more product factors 222, and the like. Also, the processing unit 102 may transmit data for recommending the pricing value via the I/O interface 114. The transmitted data may include, but is not limited to, the customer tier data 224, the product tier data 226, the grid data 228, the grid analysis data 230, the request data 232, the pricing value data 234, and the like.

The other data 236 may comprise data, including temporary data and temporary files, generated by modules for performing the various functions of the processing unit 102. The one or more modules 116 may also include other modules 214 to perform various miscellaneous functionalities of the processing unit 102. It will be appreciated that such modules may be represented as a single module or a combination of different modules.

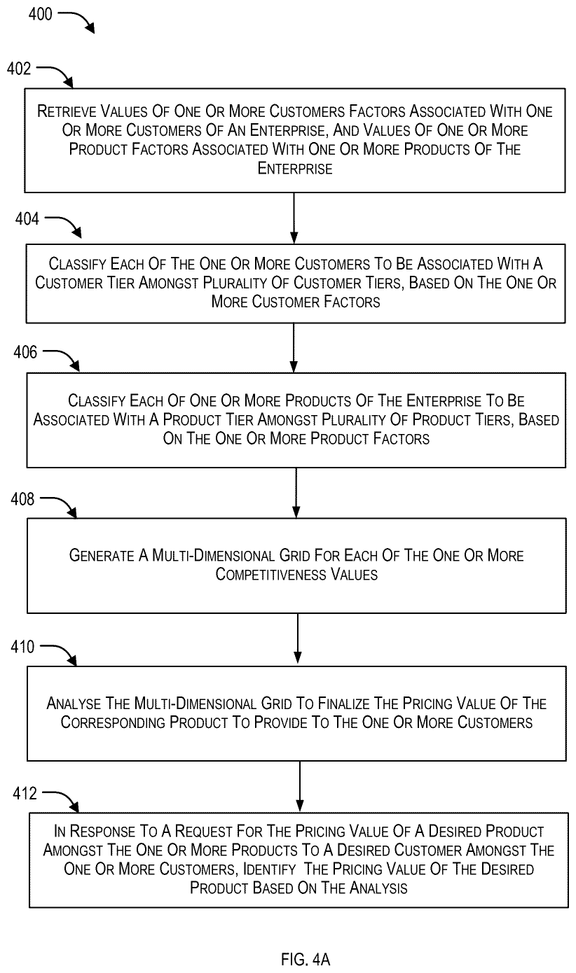

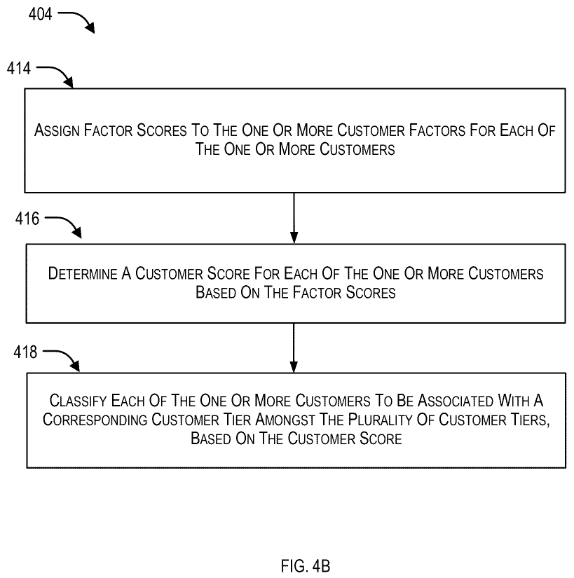

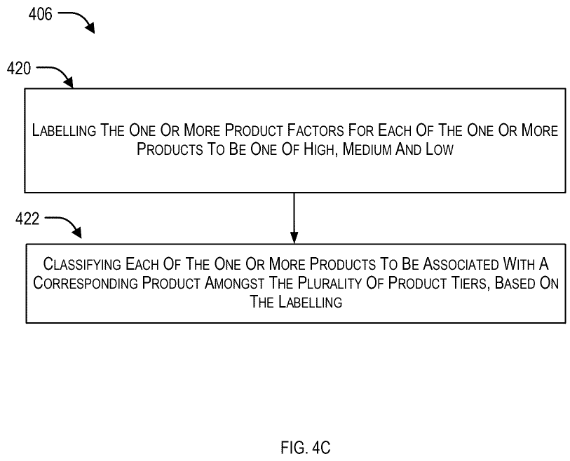

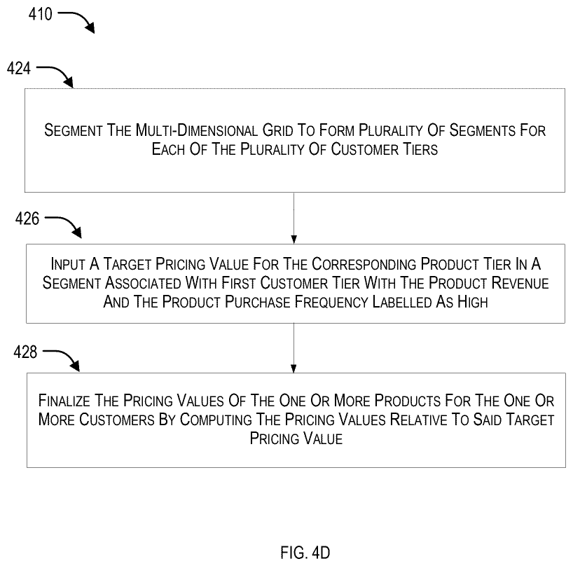

FIG. 4A shows an exemplary process of a processing unit 102 for recommending a pricing value for products of an enterprise to one or more customers, in accordance with an embodiment of the present disclosure. Process 400 for recommending the pricing value includes steps coded in form of executable instructions to be executed by a processing unit 102 associated with the enterprise with one or more products and one or more customers.

At block 402, the processing unit 102 may be configured to retrieve values of the one or more customer factors associated with one or more customers of the enterprise, and values of the one or more product factors associated with one or more products of the enterprise. In an embodiment, the one or more customer factors, associated with a customer amongst the one or more of customers, comprise at least one of the current end market position, the current customer revenue, the desired growth value, the products purchase volume, and the gross margin of the customer. In an embodiment, the one or more product factors, associated with a product amongst the one or more products, comprise at least one of the product revenue, the purchase frequency, and the one or more competitiveness values of the product.

At block 404, the processing unit 102 may be configured to classify each of the one or more customers to be associated with a customer tier amongst the plurality of customer tiers, based on the one or more customer factors. FIG. 4B shows an exemplary process of a processing unit 102 for classifying each of the one or more customers of the enterprise, in accordance with an embodiment of the present disclosure.

At block 414, the processing unit 102 may be configured to assign factor scores to the one or more customer factors for each of the one or more customers.

At block 416, the processing unit 102 may be configured to determine a customer score for each of the one or more customers based on the factor scores. In an embodiment, the customer score may be computed to be average of the values of the one or more customer factors.

At block 418, the processing unit 102 may be configured to classify each of the one or more customers to be associated with a corresponding customer tier amongst the plurality of customer tiers, based on the customer score. In an embodiment, the plurality of customer tiers may include N number of customer tiers. A customer with highest value of the customer score is classified to be associated with first customer tier and a customer with lowest value of the customer score is classified to be associated with Nth customer tier.

At block 406, the processing unit 102 may be configured to classify each of one or more products of the enterprise to be associated with a product tier amongst plurality of product tiers, based on the one or more product factors. FIG. 4C shows an exemplary process of a processing unit 102 for classifying the one or more products of the enterprise, in accordance with an embodiment of the present disclosure.

At block 420, the processing unit 102 may be configured to label the one or more product factors for each of the one or more products to be one of high, medium, and low.

At block 422, the processing unit 102 may be configured to classify each of the one or more products to be associated with a corresponding product amongst the plurality of product tiers, based on the labeling. In an embodiment, the product revenue and the purchase frequency amongst the one or more product factors may be considered to classify the one or more products. In an embodiment, a two-dimensional (2D) grid may be generated to represent the plurality of product tiers. In such 2D grid, first dimension may indicate values of the product revenue and the second dimension may indicate the values of the purchase frequency. Each of the one or more products may be placed within the 2D grid at corresponding values of the product revenue and the purchase frequency.

At block 408, the processing unit 102 may be configured to generate a multi-dimensional grid for each of the one or more competitiveness values. The multi-dimensional grid represents relation between the product revenue and the purchase frequency of corresponding product, and the plurality of customer tiers.

At block 410, the processing unit 102 may be configured to analyse the multi-dimensional grid to finalize the pricing value of the corresponding product to provide to the one or more customers. FIG. 4D shows an exemplary process of a processing unit 102 for analysing the multi-dimensional grid, in accordance with an embodiment of the present disclosure.

At block 424, the processing unit 102 may be configured to segment the multi-dimensional grid to form a plurality of segments for each of the plurality of customer tiers. Each segment of the plurality of segments associated with a customer tier indicates historic pricing values under every label of the product revenue and the product purchase frequency of the corresponding product tier.

At block 426, the processing unit 102 may be configured to input a target pricing value for the corresponding product tier in a segment associated with first customer tier with the product revenue and the product purchase frequency labeled as high.

At block 428, the processing unit 102 may be configured to finalize the pricing values of the one or more products for the one or more customers by computing the pricing values relative to said target pricing value.

At block 412, in response to a request for the pricing value of a desired product amongst the one or more products to a desired customer amongst the one or more customers, the processing unit 102 may be configured to identify the pricing value of the desired product based on the analysis, to provide the pricing value to the desired customer. In an embodiment, the processing unit 102 may be configured to analyze the plurality of product tiers and the plurality of the customer tiers to initiate the request for the pricing value. In an embodiment, the request may be associated with one of a new pricing or revised pricing of the product. In an embodiment, the pricing value recommended to the user is one of a fixed price of the desired product and a discount value offered on the fixed price of the desired product.

In an embodiment, the processing unit 102 may be configured to perform all the steps of the methods 400, 404, 406 and 410, upon receiving the request. In an embodiment, the processing unit 102 may be configured to perform some of the steps from the methods 400, 404, 406, and 410, prior to receiving the request. Upon receiving the request, other steps of the methods 400, 404, 406, and 410 may be performed in real-time to recommend the pricing value.

As illustrated in FIGS. 4A, 4B, 4C, and 4D, the methods 400, 404, 406, and 410 may include one or more steps for executing processes in the processing unit 102. The methods 400, 404, 406, and 410 may be described in the general context of computer executable instructions. Generally, computer executable instructions can include routines, programs, objects, components, data structures, procedures, modules, and functions, which perform particular functions or implement particular abstract data types.

The order in which steps in the methods 400, 404, 406, and 410 are described may not intended to be construed as a limitation, and any number of the described method steps can be combined in any order to implement the method. Additionally, individual steps may be deleted from the methods without departing from the scope of the subject matter described herein. Furthermore, the method can be implemented in any suitable hardware, software, firmware, or combination thereof.

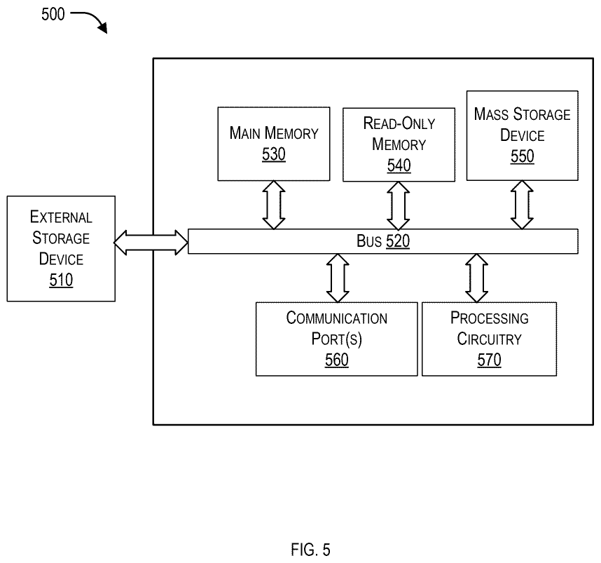

FIG. 5 illustrates an exemplary computer system in which or with which embodiments of the present invention may be utilized. Depending upon the particular implementation, the various process and decision blocks described above may be performed by hardware components, embodied in machine-executable instructions, which may be used to cause a general-purpose or special-purpose processor programmed with the instructions to perform the steps or the steps may be performed by a combination of hardware, software and/or firmware. As shown in FIG. 5, the computer system 500 includes an external storage device 510, bus 520, main memory 530, read-only memory 540, mass storage device 550, communication port(s) 560, and processing circuitry 570.

Those skilled in the art will appreciate that the computer system 500 may include more than one processing circuitry 570 and one or more communication ports 560. The processing circuitry 570 should be understood to mean circuitry based on one or more microprocessors, microcontrollers, digital signal processors, programmable logic devices, Field-Programmable Gate Arrays (FPGAs), Application-Specific Integrated Circuits (ASICs), etc., and may include a multi-core processor (e.g., dual-core, quadcore, Hexa-core, or any suitable number of cores) or supercomputer. In some embodiments, the processing circuitry 570 is distributed across multiple separate processors or processing units, for example, multiple of the same type of processing units (e.g., two Intel Core i7 processors) or multiple different processors (e.g., an Intel Core i5 processor and an Intel Core i7 processor). Examples of the processing circuitry 570 include, but are not limited to, an Intel® Itanium® or Itanium 2 processor(s), or AMD® Opteron® or Athlon MP® processor(s), Motorola® lines of processors, System on Chip (SoC) processors or other future processors. The processing circuitry 570 may include various modules associated with embodiments of the present disclosure.

The communication port 560 may include a cable modem, Integrated Services Digital Network (ISDN) modem, a Digital Subscriber Line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. The communication port 560 may be any RS-232 port for use with a modem-based dialup connection, a 10/100 Ethernet port, a Gigabit, or a 10 Gigabit port using copper or fiber, a serial port, a parallel port, or other existing or future ports. The communication port 560 may be chosen depending on a network, such as a Local Area Network (LAN), Wide Area Network (WAN), or any network to which the computer system 500 may be connected.

The main memory 530 may include Random Access Memory (RAM) or any other dynamic storage device commonly known in the art. Read-only memory (ROM) 540 may be any static storage device(s), e.g., but not limited to, a Programmable Read-Only Memory (PROM) chips for storing static information, e.g., start-up or BIOS instructions for the processing circuitry 570.

The mass storage device 550 may be an electronic storage device. As referred to herein, the phrase “electronic storage device” or “storage device” should be understood to mean any device for storing electronic data, computer software, or firmware, such as random-access memory, read-only memory, hard drives, optical drives, Digital Video Disc (DVD) recorders, Compact Disc (CD) recorders, BLU-RAY disc (BD) recorders, BLU-RAY 3D disc recorders, Digital Video Recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement the main memory 530. The mass storage device 550 may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

The bus 520 communicatively couples the processing circuitry 570 with the other memory, storage, and communication blocks. The bus 520 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processing circuitry 570 to the software system.

Optionally, operator and administrative interfaces, e.g., a display, keyboard, and a cursor control device, may also be coupled to the bus 520 to support direct operator interaction with the computer system 500. Other operator and administrative interfaces may be provided through network connections connected through the communication port(s) 560. The external storage device 510 may be any kind of external hard drives, floppy drives, IOMEGA® Zip Drives, Compact Disc—Read-Only Memory (CD-ROM), Compact Disc—Re-Writable (CD-RW), Digital Video Disk—Read Only Memory (DVD-ROM). The components described above are meant only to exemplify various possibilities. In no way should the aforementioned exemplary computer system limit the scope of the present disclosure.

The computer system 500 may be accessed through a user interface. The user interface application may be implemented using any suitable architecture. For example, it may be a stand-alone application wholly implemented on the computer system 500. The user interfaces application and/or any instructions for performing any of the embodiments discussed herein may be encoded on computer-readable media. Computer-readable media includes any media capable of storing data. In some embodiments, the user interface application is client-server-based. Data for use by a thick or thin client implemented on electronic device computer system 500 is retrieved on-demand by issuing requests to a server remote to the computer system 500. For example, computer system 500 may receive inputs from the user via an input interface and transmit those inputs to the remote server for processing and generating the corresponding outputs. The generated output is then transmitted to the computer system 500 for presentation to the user.

While embodiments of the present invention have been illustrated and described, it will be clear that the invention is not limited to these embodiments only. Numerous modifications, changes, variations, substitutions, and equivalents, will be apparent to those skilled in the art without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded to the widest scope consistent with the principles and novel features disclosed herein. It is contemplated that additional embodiments are within the spirit and true scope of the disclosed subject matter.

1. A method for recommending a pricing value for one or more products of an enterprise to one or more customers, the method comprising:
retrieving, by a processing unit, values of one or more customer factors associated with one or more customers of an enterprise, and values of one or more product factors associated with one or more products of the enterprise, wherein the one or more customer factors, associated with a customer amongst the one or more of customers, comprise at least one of current end market position, current customer revenue, desired growth value, products purchase volume and gross margin of the customer, wherein the one or more product factors, associated with a product amongst the one or more products, comprise at least one of product revenue, purchase frequency, and one or more competitiveness values of the product;
classifying, by a processing unit, each of the one or more customers to be associated with a customer tier amongst plurality of customer tiers, based on the one or more customer factors;
classifying, by the processing unit, each of one or more products of the enterprise to be associated with a product tier amongst plurality of product tiers, based on the one or more product factors;
generating, by the processing unit, a multi-dimensional grid for each of the one or more competitiveness values, wherein the multi-dimensional grid represents relation between the product revenue and the purchase frequency of a corresponding product, and the plurality of customer tiers;
analyzing, by the processing unit, the multi-dimensional grid to finalize the pricing value of the corresponding product to provide to the one or more customers; and
in response to a request for the pricing value of a desired product amongst the one or more products to a desired customer amongst the one or more customers, identifying, by the processing unit, the pricing value of the desired product based on the analysis, to provide to the desired customer.

2. The method of claim 1, further comprises:
analyzing, by the processing unit, the plurality of product tiers and the plurality of the customer tiers to initiate the request for the pricing value of the desired product.

3. The method of claim 1, wherein classifying each of the one or more customers comprises:
assigning factor scores to the one or more customer factors for each of the one or more customers;
determining a customer score for each of the one or more customers based on the factor scores; and
classifying each of the one or more customers to be associated with a corresponding customer tier amongst the plurality of customer tiers, based on the customer score.

4. The method of claim 3, wherein the plurality of customer tiers comprises N number of customer tiers, wherein a customer with highest value of the customer score is classified to be associated with first customer tier and a customer with lowest value of the customer score is classified to be associated with Nth customer tier.

5. The method of claim 1, wherein classifying each of the one or more products comprises:
labeling the one or more product factors for each of the one or more products to be one of high, medium, and low;
classifying each of the one or more products to be associated with a corresponding product tier amongst the plurality of product tiers, based on the labeling.

6. The method of claim 1, wherein analyzing the multi-dimensional grid related to a selected product tier comprises:
segmenting the multi-dimensional grid to form a plurality of segments for each of the plurality of customer tiers, wherein each segment of the plurality of segments associated with a customer tier indicates historic pricing values under every label of the product revenue and the product purchase frequency of the corresponding product tier;
inputting a target pricing value for the corresponding product tier in a segment associated with first customer tier with the product revenue and the product purchase frequency labeled as high; and
finalizing the pricing values of the one or more products for the one or more customers by computing the pricing values relative to said target pricing value.

7. The method of claim 6, wherein identifying the pricing value of the desired product comprises:
selecting a segment from the plurality of segments, associated with the desired product and the desired customer; and
analyzing the segment to identify the pricing value of the desired product.

8. The method of claim 1, wherein the products purchase volume represents at least one of historic volume of purchase, desired volume of purchase, and deviation volume of purchase of the product by the customer, wherein the deviation volume is difference between committed purchase and actual purchase of the product by the customer.

9. The method of claim 1, wherein the request is associated with one of a new pricing or revised pricing of the product.

10. The method of claim 1, wherein the pricing value recommended to the user is one of a fixed price of the desired product and a discount value offered on the fixed price of the desired product.

11. A processing unit for recommending a pricing value for one or more products of an enterprise to one or more customers, the processing unit comprises:
one or more processors; and
a memory communicatively coupled to the one or more processors, wherein the memory stores processor-executable instructions, which, on execution, cause the one or more processors to:
retrieve values of one or more customer factors associated with one or more customers of an enterprise, and values of one or more product factors associated with one or more products of the enterprise, wherein the one or more customer factors, associated with a customer amongst the one or more of customers, comprise at least one of current end market position, current customer revenue, desired growth value, products purchase volume and gross margin of the customer, wherein the one or more product factors, associated with a product amongst the one or more products, comprise at least one of product revenue, purchase frequency, and one or more competitiveness values of the product;
classify each of the one or more customers to be associated with a customer tier amongst plurality of customer tiers, based on the one or more customer factors;
classify each of one or more products of the enterprise to be associated with a product tier amongst plurality of product tiers, based on the one or more product factors;
generate a multi-dimensional grid for each of the one or more competitiveness values, wherein the multi-dimensional grid represents relation between the product revenue and the purchase frequency of a corresponding product, and the plurality of customer tiers;
analyze the multi-dimensional grid to finalize the pricing value of the corresponding product to provide to the one or more customers; and
in response to a request for the pricing value of a desired product amongst the one or more products to a desired customer amongst the one or more customers, identify the pricing value of the desired product based on the analysis, to provide to the desired customer.

12. The processing unit of claim 11, further comprises to analyze the plurality of product tiers and the plurality of the customer tiers to initiate the request for the pricing value of the desired product.

13. The processing unit of claim 11, wherein classifying each of the one or more customers comprises to:
assign factor scores to the one or more customer factors for each of the one or more customers;
determine a customer score for each of the one or more customers based on the factor scores; and
classify each of the one or more customers to be associated with a corresponding customer tier amongst the plurality of customer tiers, based on the customer score,
wherein the plurality of customer tiers comprises N number of customer tiers, wherein a customer with highest value of the customer score is classified to be associated with first customer tier and a customer with lowest value of the customer score is classified to be associated with Nth customer tier.

14. The processing unit of claim 11, wherein classifying each of the one or more products comprises to:
label the one or more product factors for each of the one or more products to be one of high, medium, and low;
classify each of the one or more products to be associated with a corresponding product tier amongst the plurality of product tiers, based on the labeling.

15. The processing unit of claim 11, wherein analyzing the multi-dimensional grid related to a selected product tier comprises to:
segment the multi-dimensional grid to form a plurality of segments for each of the plurality of customer tiers, wherein each segment of the plurality of segments associated with a customer tier indicates historic pricing values under every label of the product revenue and the product purchase frequency of the corresponding product tier;
input a target pricing value for the corresponding product tier in a segment associated with first customer tier with the product revenue and the product purchase frequency labelled as high; and
finalize the pricing values of the one or more products for the one or more customers by computing the pricing values relative to said target pricing value.

16. The processing unit of claim 11, wherein identifying the pricing value of the desired product comprises to:
select a segment from the plurality of segments, associated with the desired product and the desired customer; and
analyze the segment to identify the pricing value of the desired product.

17. The processing unit of claim 11, wherein the products purchase volume represents at least one of historic volume of purchase, desired volume of purchase, and deviation volume of purchase of the product by the customer, wherein the deviation volume is difference between committed purchase and actual purchase of the product by the customer.

18. The processing unit of claim 11, wherein the request is associated with one of a new pricing or revised pricing of the product.

19. The processing unit of claim 11, wherein the pricing value recommended to the user is one of a fixed price of the desired product, and a discount value offered on the fixed price of the desired product.

20. A non-transitory computer-readable medium including instructions stored thereon that when processed by one or more processors cause a system to perform operations comprising:
retrieving values of one or more customer factors associated with one or more customers of an enterprise, and values of one or more product factors associated with one or more products of the enterprise, wherein the one or more customer factors, associated with a customer amongst the one or more of customers, comprise at least one of current end market position, current customer revenue, desired growth value, products purchase volume and gross margin of the customer, wherein the one or more product factors, associated with a product amongst the one or more products, comprise at least one of product revenue, purchase frequency, and one or more competitiveness values of the product;
classifying each of the one or more customers to be associated with a customer tier amongst plurality of customer tiers, based on the one or more customer factors;
classifying each of one or more products of the enterprise to be associated with a product tier amongst plurality of product tiers, based on the one or more product factors;
generating a multi-dimensional grid for each of the one or more competitiveness values, wherein the multi-dimensional grid represents relation between the product revenue and the purchase frequency of a corresponding product, and the plurality of customer tiers;
analyzing the multi-dimensional grid to finalize the pricing value of the corresponding product to provide to the one or more customers; and
in response to a request for the pricing value of a desired product amongst the one or more products to a desired customer amongst the one or more customers, identifying the pricing value of the desired product based on the analysis, to provide to the desired customer.
